(19) United States
(12) Patent Application Publication
(10) Pub. No.: US 2007/0063831 A1
(43) Pub. Date: Mar. 22, 2007

(54) Signaling safety system

(76) Inventors: Barry Perkins, Parker, TX (US); Joseph Cordina, Parker, TX (US)

Correspondence Address: MICHAEL L. DIAZ, P.C., 555 REPUBLIC DRIVE, SUITE 200, PIANO, TX, 75074, US

(21) Appl. No.: 11/229,967

(22) Filed: Sep. 19, 2005

(51) Int. Cl. B60Q 1/44

(52) U.S. Cl. 340/479

(57) ABSTRACT

The present invention is a signaling system for a motorcycle or bicycle providing a light indication to other motorists. An indication mechanism is attached to a garment of the rider. The indication mechanism has at least two banks of LEDs arrays and a wireless radio receiver. A signal interface is linked to the wiring system of the motorcycle light system. The signal interface intercepts signals transmitted on the wiring system of the motorcycle light system. The system also includes a wireless radio transmitter in communication with the signal interface. When the signal interface detects a signal sent through the wiring system of the motorcycle, the signal interface sends a signal via the transmitter to the receiver of the indication mechanism. The indication mechanism then illuminates the appropriate bank of LED arrays to provide a light indication to warn other motorists. In an alternate embodiment of the present invention, the indication mechanism may be worn by a cyclist. The signal interface may communicate with a sensing device which receives signals from a braking mechanism of the bicycle. When the braking mechanism is actuated, the sensing device senses the braking action and sends a signal via the transmitter to the receiver of the indication mechanism, which in turn illuminates the LED arrays. Alternately, rather than utilizing a signal interface, the indication mechanism may include an accelerometer to detect deceleration of the bicycle.

### BACKGROUND OF THE INVENTION

1. Field of the Invention

This invention relates to safety devices. Specifically, the present invention relates to a signaling device mounted on a garment for use with a vehicle or bicycle.

2. Description of Related Art

Both motorcycles and bicycles make up a significant portion of the traffic on roads. However, although popular, there is extreme danger associated with riding motorcycles and bicycles on the road. One of the greatest problems associated with motorcycles and bicycles is the inability of many drivers to see the motorcycles/bicycles on the road. Because of their size, motorcycles/bicycles are oftentimes difficult to see. Additionally, because motorcycles have signaling lights which are smaller than conventional automobiles, drivers do not observe motorcycles signals when stopping, slowing, or indicating a turn. Likewise, drivers do not notice bicyclists providing hand signals. A device and system is needed which provides an enhanced signaling system to bicycles and motorcycles.

Although there are no known prior art teachings of a device such as that disclosed herein, prior art references that discuss subject matter that bears some relation to matters discussed herein are U.S. Pat. No. 5,040,099 to Harris (Harris), U.S. Pat. No. 6,097,287 to Lu (Lu), U.S. Pat. No. 6,834,395 to Fuentes (Fuentes), U.S. Pat. No. 3,906,443 to Musselman (Musselman), U.S. Pat. No. 4,769,629 to Tigwell (Tigwell), U.S. Pat. No. 5,704,707 to Gebelein et al. (Gebelein), U.S. Pat. No. 6,406,168 to Whiting (Whiting), U.S. Pat. No. 6,538,567 to Stewart (Stewart), U.S. Pat. No. 6,558,016 to Restauro (Restauro), U.S. Patent Application Publication No. 2002/0145864 to Spearing (Spearing), U.S. Patent Application Publication No. 2004/0184262 to De Silva (De Silva), and U.S. Patent Application Publication No. 2005/0134439 to Moore et al. (Moore).

Harris discloses a motorcycle safety helmet which has a rearward facing auxiliary brake lamp secured to a helmet which is connected by an optic or sonic link to the brake light system of a motorcycle. However, Harris does not teach or suggest a signaling system affixed to a garment of the rider. Harris suffers from the disadvantage of providing a signaling system to a modified helmet. Such modifications on a helmet are currently not permitted by federal law. Additionally, Harris merely discloses a system which is connected to the brake light system of a motorcycle by a sonic or optical link which can easily be broken if a clear line of sight is not provided between the helmet and the transmitting device located on the motorcycle. Additionally, Harris does not teach or suggest a system for indicating a turn.

Lu also discloses a helmet safety system which produces a supplemental warning signal when a braking system of an associated vehicle is actuated. The system includes a warning signal coupled to a wire loop and flux generator adapted to be coupled to the braking system of the vehicle. When the braking system of the vehicle is actuated, the flux generator draws current from the vehicle and the flux generator creates flux when the braking system is actuated to power the warning signal. However, Lu does not teach or suggest a signaling device worn on a jacket of the rider. Additionally, Lu does not teach or suggest the use of a wireless radio telecommunications link to the motorcycle. Likewise, Lu does not disclose a device providing a turn signal indicator. Lu suffers from the disadvantage of utilizing a complex device to interface with the braking system by requiring the use of a device providing a flux detector, thereby increasing the cost and complexity of the device.

Fuentes discloses a safety garment worn by a rider which provides a turn indication or a brake indication. The garment includes a receiver for receiving signals from the signaling system of the motorcycle. However, Fuentes does not disclose an interface for transmitting the brake or turn signal indication to the garment. Additionally, Fuentes does not teach or suggest a safety garment or accessory for use on a bicycle.

Musselman discloses an automatic brake light switch for a bicycle. A sensing device attached to the brakes of a bicycle sends a signal via a cable to a brake light located at the rear of the bicycle. Musselman does disclose a sensing device activated when the cyclist brakes. However, Musselman does not teach or suggest utilizing a wireless radio communications link to a light indication device worn by the cyclist.

Tigwell discloses an apparatus for actuating and de-actuating a brake light affixed to a motorcyclist's helmet without any interface with the motorcycle. The helmet includes an accelerometer which senses deceleration forces to trigger the brake light. Tigwell does disclose an illumination device triggered by an accelerometer. However, the illumination device of Tigwell is mounted on a helmet. Tigwell does not teach or suggest a light indication device worn on a garment or backpack of a person. Additionally, Tigwell does not teach or suggest any interface with a motorcycle (i.e., no wireless communications).

Gebelein discloses a helmet-mounted brake light system which communicates via an infrared beam with an interface device attached to a motorcycle. The interface device is a proximity switch which senses when a hand brake is actuated. The interface of Gebelein does not include an electrical interface with the wiring system of the motorcycle. Additionally, Gebelein does not teach or suggest utilizing an RF wireless communications link. Gebelein merely discloses the use of an IR communication device. Additionally, Gebelein only discloses the use of a brake light on a helmet, not a lighting system affixed to the back of the motorcyclist.

Whiting discloses a helmet light system for a motorcycle which includes a transmitter mounted on a motorcycle for broadcasting an RF signal to a receiver mounted on the helmet. The transmitter includes a microprocessor that is connected to the brake light circuit and turn light circuit. Whiting utilizes a pulse generator to illuminate the helmet mounted light. Whiting does disclose a wireless radio communications link between the motorcycle and the light device. Whiting also discloses interfacing the microprocessor with the electrical system of the motorcycle. However, Whiting does not teach or suggest the use of insulation displacement connectors (IDCs) to interface with the wiring system. In addition, Whiting does not teach or suggest a lighting system mounted to the back of the motorcyclist.

Stewart discloses a motorcycle jacket which has turn signal lights attached to the back of the jacket. The lights are physically connected to wiring system of the motorcycle electric system. Stewart discloses connecting directly to the wiring system of the motorcycle lighting system. Stewart also discloses a garment which includes a bank of lights on the back of the garment. However, Stewart does not teach or suggest utilizing an RF wireless communications link. Stewart merely splices into the wiring system of the motorcycle with a cable connected to the jacket. Additionally, Stewart only discloses a turn signal indication and not a brake indication.

Restauro discloses a garment having illuminated traffic signals. The garment includes a power cord attached to the motorcycle. In a similar fashion as described by Stewart, Restauro discloses an interface with the wiring system of the motorcycle. Restauro does disclose a garment having a bank of lights located on its back side. However, Restauro does not teach or suggest a wireless radio communications link between the garment and the motorcycle. Additionally, Restauro does not teach or suggest how the wiring system is interfaced.

Spearing discloses a light signaling system attached to a garment. The garment is connected to the lighting wiring system of a motorcycle. The light signaling system is directly connected to the wiring of the lighting system of the motorcycle. Spearing does not teach or suggest a wireless radio communications link. Additionally, Spearing does not disclose how the light system interfaces with the wiring system of the motorcycle.

De Silva discloses a safety signal jacket having a light array located on the back of the jacket. De Silva includes a control device mounted on the shoulder straps to actuate the lights. De Silva does not teach or suggest a wireless link between the garment and the jacket interfacing with the motorcycle. De Silva suffers from a major disadvantage in that the lights must be actuated by the person manipulating controls on the shoulder straps of the garment.

Moore discloses a light system mounted to a bicycle or motorcycle helmet. The lighting system includes one or more accelerometers which may be mounted in the helmet or on the bicycle/motorcycle, and a processor adapted to process the signals from the accelerometers. Moore discloses utilizing an RF link for communicating with the helmet and the accelerometer on the bicycle. However, Moore does not teach or suggest mounting a light array on the back of a garment. Additionally, Moore does not teach or suggest utilizing the RF link to communicate with a sensing device located on the brakes of a bicycle.

In regards the patents disclosing lights located on helmets worn by riders, these patents suffer from the fact that a device that is attached to helmets is against current federal regulations. Furthermore, these patents do not teach or suggest affixing the lights to directly to garments, which provides a surface area which is far more visible to other motorists. None of these patents which disclose lights on the helmet discuss the problems associated with attaching devices to helmets or the deterioration of the structural integrity of the helmet. In regards to those patents which include wires connecting a garment to the motorcycle, there are also significant safety concerns. For example, wire related injuries may result during an accident if a wire is attached between the garment and the motorcycle.

Finally, none of the patents disclose a simple way of interfacing with the motorcycle wiring system. Existing prior art references merely disclose splicing wires, which is complicated, increases the danger of electrical problems through modification of the wiring system of the motorcycle, and increases the cost of utilizing professional mechanics to install the interface.

Thus, it would be a distinct advantage to have a simple and economical signaling device worn by a rider of a bicycle or motorcycle. The device may include a wireless radio link to the motorcycle or bicycle. In regards to a motorcycle, the device should include an effective interface to the braking and signaling system. It is an object of the present invention to provide such an apparatus.

### SUMMARY OF THE INVENTION

In one aspect, the present invention is a signaling system for a motorcycle or bicycle providing a light indication to other motorists. An indication mechanism is attached to a garment of the rider. The indication mechanism has at least two banks of LEDs arrays and a wireless radio receiver. A signal interface is linked to the wiring system of the motorcycle light system. The signal interface intercepts signals transmitted on the wiring system of the motorcycle light system. The system also includes a wireless radio transmitter in communication with the signal interface. When the signal interface detects a signal sent through the wiring system of the motorcycle, the signal interface sends a signal via the transmitter to the receiver of the indication mechanism. The indication mechanism then illuminates the appropriate bank of LED arrays to provide a light indication to warn other motorists.

In another aspect, the indication mechanism may be worn by a cyclist. The signals come from a battery source and through a brake-activated sensing device which detects any braking action by a braking mechanism of the bicycle. This system also includes a wireless radio transmitter in communication with the signal interface. When the sensing device detects a braking action by the braking mechanism, the signal interface sends a signal via the transmitter to the receiver of the indication mechanism. The indication mechanism then illuminates the appropriate bank of LED arrays.

In still another aspect, the indication mechanism may be worn by a cyclist. However, rather than utilizing a signal interface, the indication mechanism may include an accelerometer to detect deceleration of the bicycle. Once deceleration of the bicycle is detected, the appropriate banks of the LED arrays on the indication mechanism illuminate.

### BRIEF DESCRIPTION OF THE DRAWINGS

FIG. 1 is a side view of a signaling system 10 worn by a rider in the preferred embodiment of the present invention;

FIG. 2 is a front view of the indication mechanism of FIG. 1;

FIG. 3 is a simplified wiring diagram of the transmitter and the signal interface of FIG. 1 in the preferred embodiment of the present invention;

FIG. 4 is a side view of a signaling system worn by a rider on a bicycle in a first alternate embodiment of the present invention; and

FIG. 5 is a front view of the indication mechanism of FIG. 4.

### DESCRIPTION OF THE INVENTION

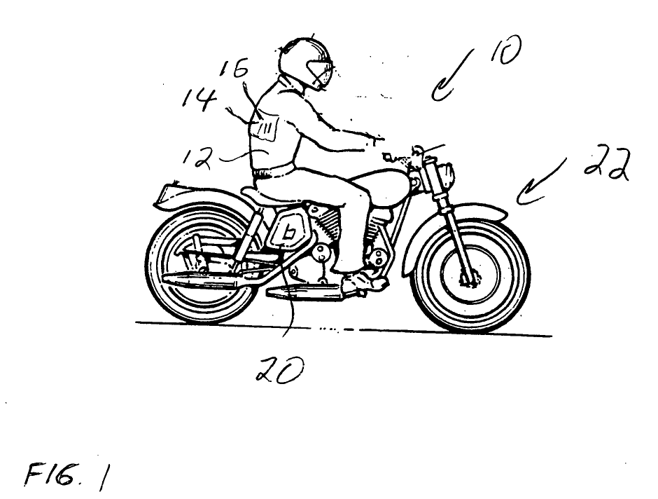

A signaling device for use by a rider on a motorcycle or bicycle is disclosed. FIG. 1 is a side view of a signaling system 10 worn by a rider 12 in the preferred embodiment of the present invention. The rider wears a jacket having an indication mechanism 14. The indication mechanism includes an LED array 16 which may provide an indication for a turn indication and brake or deceleration indications. The indication mechanism is affixed to a garment worn by the rider. The indication mechanism includes a receiver 18. The signaling system also includes a transmitter 20 affixed to a motorcycle 22. The transmitter is connected to a motorcycle signal interface 24.

Preferably, the indication mechanism is affixed to a jacket, but any garment worn by the rider may be utilized. Additionally, the indication mechanism is preferably removable and may be held in position to the garment by any attachment means, such as Velcro strips or straps. Also, in the preferred embodiment of the present invention, the indication mechanism is affixed to a jacket constructed of body armor popular with motorcyclists. In this embodiment, because of the foam construction of the body armor jacket, the indication mechanism may be imbedded within the foam to provide a flush profile with the outer surface of the jacket where the indication mechanism and the jacket meet.

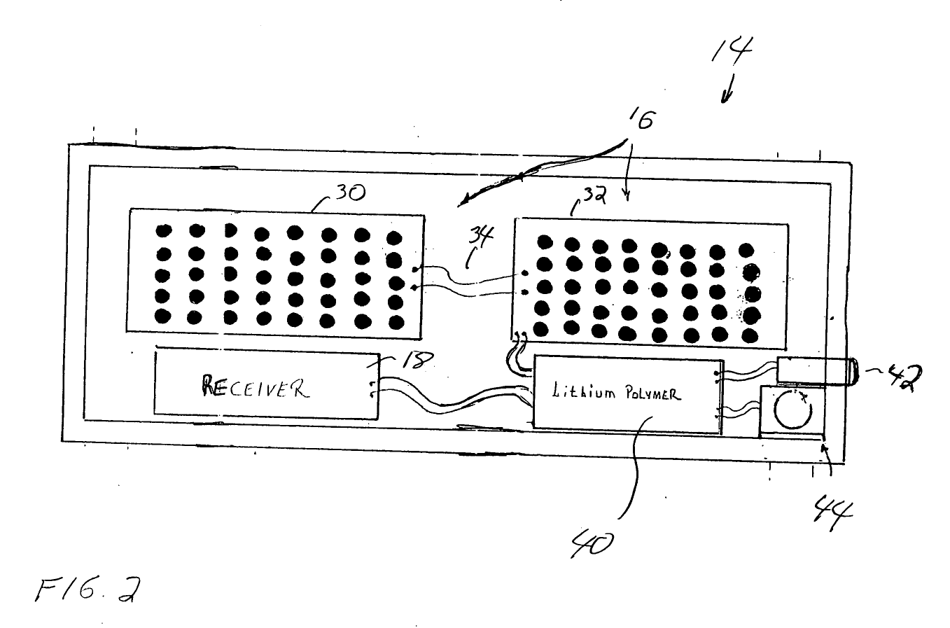

FIG. 2 is a front view of the indication mechanism 14 of FIG. 1. The indication mechanism includes the LED array 16 which may include two banks 30 and 32 of LEDs. The LEDs are preferably separated into banks to provide corresponding turn signal indications. For example, a left signal is shown by illuminating the left bank 30 of LEDs. The bank 30 may include a flashing illumination of the LEDs. Likewise, the right bank 32 of lights illuminate for a right signal. The lights may form an arrow for turn indications. The banks 30 and 32 may be connected by wires 34 to provide a synchronized operation of the LEDs. For braking action, both banks of lights may be illuminated. Preferably, the LED array includes both amber and/or red lights. The red lights may be illuminated for a brake indication while amber or red lights illuminate for turn indications. In the preferred embodiment of the present invention, the indication mechanism is covered by an acrylic fresnel lens. A fresnel lens magnifies the illuminated light and provides a protective layer for the indication mechanism. Additionally, a fabric mesh material may be overlaid to hide the indication mechanism from view but still allow the LEDs to show through the material.

The indication mechanism 14 also includes the receiver 18 and a power source 40. The power source is preferably a lithium battery or series of batteries used for powering the indication mechanism 14. In the preferred embodiment of the present invention, the lithium power source includes a recharge port 42 allowing an AC/DC adapter cable to be attached to the indication mechanism for recharging the indication mechanism. Additionally, the indication mechanism preferably includes an accelerometer 44. The accelerometer 44 senses motion of the garment and indication mechanism. When the accelerometer senses motion, the indication mechanism changes from a “sleeper” mode to an active mode. In the active mode, the receiver is powered to receive any signals from the transmitter. After a period of time (e.g., 2 minutes) without sensing any motion by the accelerometer, the indication mechanism goes to the sleeper mode, which powers down all systems, thereby preserving the battery power. Thus, when the garment is not in use (e.g., in a closet), the indication mechanism is powered to off to preserve battery power. However, once the garment is moved, the accelerometer automatically turns the light mechanism to the powered position without any intervention by the motorcyclist. In an alternate embodiment of the present invention, rather than utilizing an accelerometer, an on/off switch may be used. Although not shown in FIG. 2, the indication mechanism may include a hook and loop assembly affixed to a back surface of the indication mechanism. The hook and loop assembly includes a corresponding hook and loop assembly on the garment of the rider 12. Alternatively or in conjunction with the hook and loop assemblies, the indication mechanism may include straps. It should be understood that any mechanism allowing the attachment of the indication mechanism to a garment or body of the rider may be utilized. Additionally, the indication mechanism may be covered by a transparent acrylic lens to protect the components of the indication mechanism while allowing the LEDs to shine through the lens.

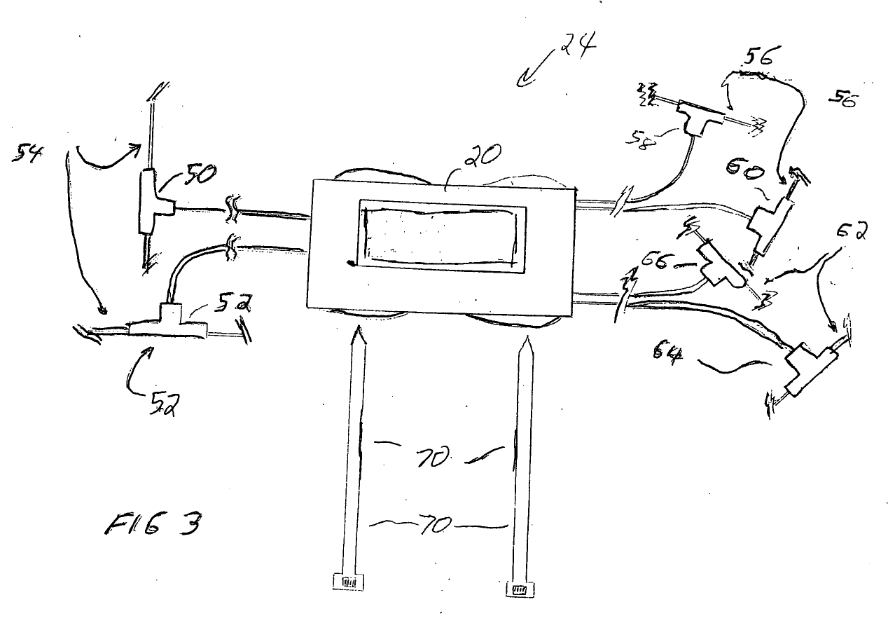

FIG. 3 is a simplified wiring diagram of the transmitter 20 and the signal interface 24 of FIG. 1 in the preferred embodiment of the present invention. Since the transmitter and signal interface are connected to the wiring associated with the brake and turn indicators of the motorcycle, no battery is necessary although in an alternate embodiment of the present invention, a battery may be provided as an independent power source. The transmitter is connected to the lighting system of the motorcycle through a plurality of insulation displacement connectors (IDCs). For example, IDC 50 and 52 are connected to the tail light wires 54. The tail light wires are associated to any braking action by the motorcycle which typically illuminates the motorcycle's brake lights. The right turn signal wires 56 of the motorcycle are connected to IDCs 58 and 60. In addition, the left turn signal wires 62 of the motorcycle are connected to the IDCs 64 and 66. The IDCs enable the transmitter to receive the light signals of the motorcycle and transmit these signals to the indication mechanism 14. The IDCs enable the interface with the motorcycle wiring system without the need for splicing or cutting of the motorcycling wiring system. The signal interface arrangement utilized in the present invention provides minimal and economical modifications to the motorcycle allowing the use of the signaling system on any motorcycle with ease and simplicity.

The transmitter 20 is preferably a radio frequency (RF) transmitter providing a wireless communication to the receiver 18. However, any wireless radio protocol and transmitter may be utilized for transmitting signals to the indication mechanism 14. In the preferred embodiment of the present invention, the transmitter transmits to a specific separate address associated with one receiver. Thus, the transmitter does not inadvertently provide signals to other light indication mechanisms worn by other motorcyclists in close proximity to the first transmitter.

The transmitter may be affixed to the motorcycle in any location. Any attachment means may also be utilized. However, in the preferred embodiment of the present invention, the transmitter is affixed to a back portion of a license plate bolt of the motorcycle. Alternatively, the transmitter may be affixed by one or more cable ties 70 directly to any part of the motorcycle.

With reference to FIGS. 1-3, the operation of the signaling system 10 for a motorcycle 22 will now be explained. The transmitter 20 is affixed to the motorcycle 22. Preferably, the transmitter is affixed to a license plate bolt of the motorcycle. The transmitter is connected to the brake/signal indication wiring system of the motorcycle by the signal interface 24. A plurality of IDCs is utilized to connect and provide signals generated by the wiring of the motorcycle to the transmitter. For example, if the rider brakes, the brake lights of the motorcycle are illuminated by providing a signal through the tail light wires 54. The signals received by the tail light wires 54 are routed through the IDCs 50 and 52 to the transmitter 20. The tail light signals are then transmitted to the indication mechanism 14 which is received by the receiver 18. The receiver, through a computer processor (not shown), routes the signal to the LED array 18 which illuminated both banks 30 and 32. Preferably, red LED lights are illuminated. The LED lights may be set on a timer (not shown) which allows the LED lights to remain illuminated for a set period of time before going off (e.g., 3 seconds). Alternatively, the LED lights may be extinguished when the tail lights are extinguished, which occurs when the signal sent through the tail light wires 54 is terminated.

In a similar manner, the turn signal indications are propagated when a turn signal on the motorcycle is used, thereby sending a signal to one of the turn signal wires. If the right turn signal is illuminated on the motorcycle, a signal is sent through the right turn signal wires 56 which, in turn is intercepted by the IDCs 58 and 60. The IDCs send the signal to the transmitter 20 which is received by the receiver 18. The receiver, through the processor, sends a signal to the right bank 32 to illuminate the LED lights of the right bank. The right bank 32 is normally off and automatically extinguishes when the turn signal is cancelled. The computer processor may be able to distinguish between a brake light and a turn signal, thus sending the appropriate signal to the bank 30 or 32 to either flash or illuminate constantly. For example, if the brake light is applied and the right turn indicator is on, the right bank 32 flashes while the left bank illuminates constantly. Alternatively, the lights may be set to a timer to extinguish after a predetermined time period.

The signaling system 10 provides a simple interface to the motorcycle's wire system and enables an additional light indication which provides a superior lighting indication for other motorists. The signal system is easily installed on the motorcycle and may be easily attached to a garment of the rider. The present system utilizes an interface which does not require extensive rewiring of the motorcycle, but rather, taps into the existing wiring system without the need to splice or cut the existing motorcycle wiring system.

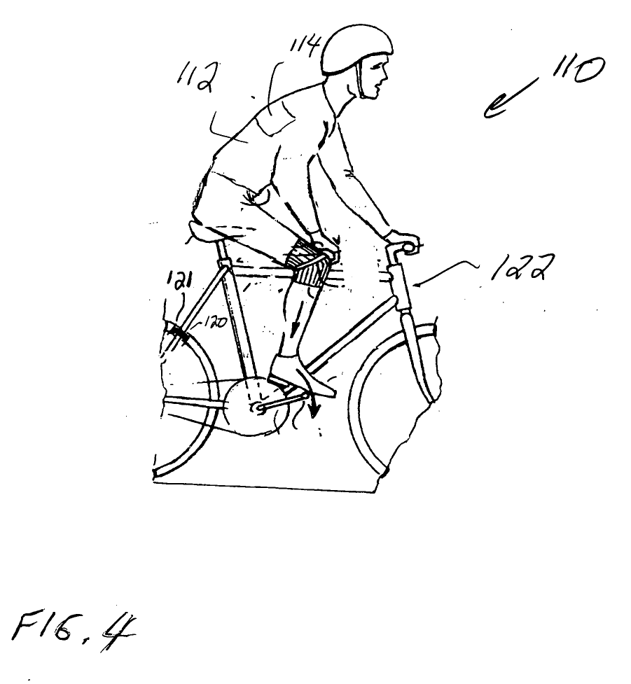

FIG. 4 is a side view of a signaling system 110 worn by a rider 112 on a bicycle 122 in a first alternate embodiment of the present invention. The rider wears a garment or camelback watering system having an indication mechanism 114. The indication mechanism includes an LED array 116 which may provide an indication for brake or deceleration indications. The indication mechanism is affixed to a garment worn by the rider.

Preferably, the indication mechanism is affixed to a backpack or camelback watering device commonly worn by cyclists, but any garment worn by the rider may be utilized. Additionally, the indication mechanism is preferably removable and may be held by an attachment means such as Velcro strips or straps.

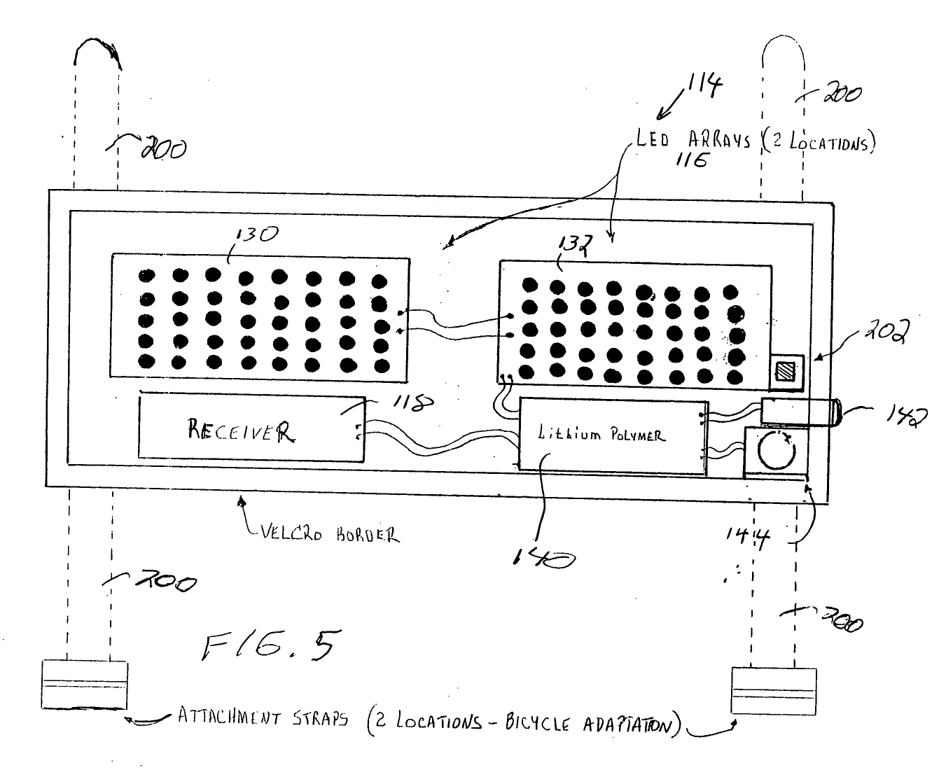

FIG. 5 is a front view of the indication mechanism 114 of FIG. 4. The indication mechanism includes the LED array 116 which may include two banks 130 and 132 of LEDs. For braking action or deceleration of the bicycle, both banks of lights may be illuminated. Preferably, the LED array includes red lights. The red lights may be illuminated for a brake or deceleration indication.

The indication mechanism 114 also includes an optional receiver 118 and a power source 140. The power source is preferably a lithium battery or series of batteries used for powering the indication mechanism 114. In the preferred embodiment of the present invention, the lithium power source includes a recharge port 142 allowing an AC/DC adapter cable to be attached to the indication mechanism for recharging the indication mechanism. Additionally, the indication mechanism preferably includes an accelerometer 144. The accelerometer 144 senses motion of the garment and indication mechanism. When the accelerometer senses motion, the indication mechanism changes from a “sleeper” mode to an active mode. In the active mode, the receiver is powered to receive any signals from the transmitter. After a period of time (e.g., 2 minutes) without sensing any motion by the accelerometer, the indication mechanism goes to the sleeper mode, which powers down all systems, thereby preserving the battery power. Thus, when the garment is not in use (e.g., in a closet), the indication mechanism is powered to off to preserve batter power. However, once the garment is moved, the accelerometer automatically turns the light mechanism to the powered position without any intervention by the cyclist. In an alternate embodiment of the present invention, rather than utilizing an accelerometer, an on/off switch may be used. Although not shown in FIG. 5, the indication mechanism may include a hook and loop assembly affixed to a back surface of the indication mechanism. The hook and loop assembly includes a corresponding hook and loop assembly on the garment/camelback of the rider 112. In the preferred embodiment of the present invention, the indication mechanism may include straps 200. It should be understood that any mechanism allowing the attachment of the indication mechanism to a garment or body of the rider may be utilized. Additionally, the indication mechanism may be covered by a transparent acrylic lens to protect the components of the indication mechanism while allowing the LEDs to shine through the lens.

The indication mechanism also includes an accelerometer 202. A single-axis accelerometer may be utilized to sense any deceleration of the bicycle. However, any type of accelerometer may be utilized, such as a three axis accelerometer. The accelerometer may be located on the indication mechanism or affixed separately on the bicycle. If the accelerometer is located on the bicycle, the transmitter 120 is installed on the bicycle to communicate the signals received from the accelerometer to the receiver within the indication mechanism. However, preferably, the accelerometer is mounted in the indication mechanism 114. In this case, no wireless transmitting device is needed.

If the transmitter is utilized, the transmitter 220 may utilize an RF transmitter providing a wireless communication to the receiver 118. However, any wireless radio protocol and transmitter may be utilized for transmitting signals to the indication mechanism 114. In the preferred embodiment of the present invention, the transmitter transmits to a specific separate address associated with one receiver. Thus, the transmitter does not inadvertently provide signals to other light indication mechanisms worn by other cyclists in close proximity to the first transmitter.

With reference to FIGS. 4 and 5, the operation of the signaling system 110 for the bicycle 122 will now be explained. The indication mechanism 114 is attached to the back of the rider, either to the rider's garment or to a backpack or camelback worn by the rider. When the accelerometer 202 senses a deceleration of the bicycle, the accelerometer sends a signal via a processor (not shown). The processor then sends a signal to illuminate the LED array. The accelerometer may optionally sense movement of the rider moving forward as well as the deceleration of the bicycle. Thus, the rider may move his torso forward to cause the accelerometer to sense a “deceleration.” In turn, the indication mechanism may illuminate the LED array. The LED array preferably remains illuminated for a predetermined time, such as 1 to 4 seconds and then automatically extinguishes.

In an alternate embodiment of the present invention, the accelerometer 202 or an additional accelerometer may be used to provide a signal through the processor to the LED array to illuminate a turn signal indication. The accelerometer may sense the cyclist leaning to the left side or the right side and provide a corresponding signal to the LED array. The LED array may include a turn signal indication in a similar fashion as described for the motorcycle embodiment. Thus, the cyclist when desiring to illuminate a turn signal indication, leans in the desired direction (i.e., right or left), which illuminates the appropriate LED array. Additionally, the accelerometer may detect the centrifugal forces when the cyclist is turning, thereby sending a signal to the appropriate LED array to provide a turn signal indication.

In another alternate embodiment of the present invention, in place of an accelerometer, the signaling system may also include an optional transmitter 120 affixed to a sensing device 121 (see FIG. 4). The sensing device 121 may be attached to a brake of the bicycle 122. The optional transmitter may be powered by a rechargeable or non-rechargeable lithium battery that sends a signal to a receiver when power is received through a switch. The sensing device senses when the brake is applied to the wheel of the bicycle. Upon detecting the braking action of the bicycle brake, the sensing device transmits a signal to the receiver 118 of the indication mechanism. Upon receipt of the signal by the receiver, the indication mechanism illuminates the LED array.

The signaling system 110 of the present invention provides a signaling device worn by a cyclist to warn other motorists that the cyclist is decelerating or stopping. In an alternate embodiment of the present invention, the signaling system may include a turn indication signal as described for the signaling system 10.

In still another alternate embodiment of the present invention, the indication mechanism may be affixed to a back portion of a trailer pulled by a vehicle. The vehicle may incorporate the signal interface 24 within the vehicle and transmit a signal to the indication mechanism on the trailer.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A signaling system worn by a rider of a motorcycle, the signaling system comprising:
an indication mechanism attached to a garment worn on the body of the rider, the indication mechanism having a light array with a plurality of lights, the indication mechanism having a wireless radio receiver;
a signal interface linked to a wiring system of the motorcycle light system, the signal interface intercepting signals transmitting on the wiring system of the motorcycle light system and having a wireless radio transmitter;
whereby the signal interface provides a signal via the transmitter to the receiver of the indication mechanism when a motorcycle light signal is sent through the wiring system of the motorcycle, the indication mechanism illuminating at least a portion of the light array.

2. The signaling system of claim 1 wherein the signal interface is linked to the wiring system by a plurality of insulation displacement connectors (IDCs) connected to the wiring system of the motorcycle.

3. The signaling system of claim 2 wherein a first IDC is connected to a first wire associated with a left turn motorcycle indicator light and a second IDC is connected to a second wire associated with a right turn motorcycle indicator light.

4. The signaling system of claim 3 wherein a third IDC is connected to a third wire associated with a motorcycle brake light.

5. The signaling system of claim 1 further comprising an accelerometer sensing motion of the indication mechanism, whereby the indication mechanism is powered to receive a signal from the transmitter when the accelerometer senses motion.

6. The signaling system of claim 1 wherein the light array includes at least two banks of LED arrays.

7. The signaling system of claim 6 wherein the indication mechanism includes a processor for determining if a received signal is associated with a motorcycle indicator light.

8. The signaling system of claim 7 wherein the indication mechanism illuminates a left bank of LED arrays when processor determines that a signal is received associated with a motorcycle left turn indicator light and illuminates a right bank of LED arrays when the processor determines that a signal is received associated with a motorcycle right turn indicator light.

9. The signaling system of claim 7 wherein the indication mechanism illuminates both banks of LED arrays when the processor determines that a signal is received associated with a motorcycle brake light indication.

10. The signaling system of claim 7 wherein the indication mechanism illuminates a left bank of LED arrays when processor determines that a signal is received associated with a motorcycle left turn indicator light, illuminates a right bank of LED arrays when the processor determines that a signal is received associated with a motorcycle right turn indicator light, and illuminates both banks of LED arrays when the processor determines that a signal is received associated with a motorcycle brake light indication.

11. A signaling system worn by a cyclist of a bicycle, the signaling system comprising:
an indication mechanism attached to the cyclist, the indication mechanism having a light array with a plurality of lights; and
at least one accelerometer attached to the indication system, the accelerometer capable of sensing a deceleration of the cyclist;
whereby the signal interface illuminates the light array when the accelerometer senses a deceleration.

12. The signaling system of claim 11 wherein the indication mechanism is attached to a backpack worn by the cyclist.

13. The signaling system of claim 11 wherein the indication mechanism is attached to a camelback worn by the cyclist.

14. The signaling system of claim 11 wherein the indication mechanism is attached to a garment worn by the cyclist.

15. The signaling system of claim 11 wherein the accelerometer senses a forward movement of the torso of the cyclist, whereby the indication mechanism illuminates the light array when the accelerometer senses a forward movement.

16. The signaling system of claim 11 wherein the accelerometer may sense side forces wherein the indication mechanism illuminates the light array to provide a turn signal indication upon detection of a side force by the accelerometer.

17. A signaling system worn by a cyclist of a bicycle, the signaling system comprising:
an indication mechanism attached to the cyclist, the indication mechanism having a light array with a plurality of lights and a wireless radio receiver;
a sensing device linked to a brake of the bicycle, the sensing device sensing any braking action by the brake, the sensing device having a wireless radio transmitter;
whereby the sensing device provides a signal via the transmitter to the receiver of the indication mechanism when the sensing device senses a braking action by the brake of the bicycle, the indication mechanism illuminating the light array.

18. The signaling system of claim 17 wherein the indication mechanism is attached to a backpack worn by the cyclist.

19. The signaling system of claim 17 wherein the indication mechanism is attached to a camelback worn by the cyclist.

20. The signaling system of claim 16 further comprising an accelerometer sensing motion of the indication mechanism, whereby the indication mechanism is powered to receive a signal from the transmitter when the accelerometer senses motion.
